(19) United States
(12) Patent Application Publication
(10) Pub. No.: US 2008/0294642 A1
(43) Pub. Date: Nov. 27, 2008

(54) REMOTE SERVICE SYSTEM AND METHOD FOR FUNCTIONALLY CONSTRAINED DATA PROCESSING DEVICES

(76) Inventors: Silvy Wilson, Rancho Santa Margarit, CA (US); Man Mohan Garg, Cerritos, CA (US); Alok Mathur, Lake Forest, CA (US); Fabio Gava, Ladera Ranch, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/751,376

(22) Filed: May 21, 2007

(51) Int. Cl. G06F 17/30

(52) U.S. Cl. 707/10; 707/E17.032

(57) ABSTRACT

The subject application is directed to a system and method for a system and method for providing remote service to functionally constrained data processing devices. A server first receives feature identification data representing available services requested from each of a plurality of data processing devices. Instructions corresponding to each of the available services is then stored in association with the server. The feature identification data is then tested so as to determine whether the feature is available locally or requires access to an associated data repository, such as the Internet. The instructions associated with each received feature identification data are then processed so as to complete a corresponding service. The associated repository is then accessed when the result of the testing indicates that the feature is not available locally. Thereafter, result data associated with each requested service is then communicated to the data processing device associated with the service request.

### BACKGROUND OF THE INVENTION

The subject application is directed generally to providing services to capacity constrained processing devices. More particularly, the subject teachings are advantageously used in providing services typically unavailable to devices which lack an ability to perform them on their own, such as with cell phones, personal digital assistants, electronic mail devices, and the like.

There is a proliferation of dedicated information processing devices which include scaled-back versions of general purpose processing devices, including a processor memory, an input and a display, as well as mechanism for data interchange with one or more other devices. Many such devices are directed to one or more specialized operations, such as will electronic mail devices such as Research in Motion's BLACKBERRY or Palm Computing's TREO device, by of example only. Additionally, devices such as cell phones include data processing capability, and are therefore adaptable to functions, such as text messaging, game play, or running of other applications to the extent possible on their constrained platforms. Limitations in processing power, display size, available memory, communication bandwidth, and available power prevent completion of many operations on such devices.

While it would be advantageous to use such constrained devices in connection with other desired services, the limitations in device infrastructure precludes this from happening.

### SUMMARY OF THE INVENTION

In accordance with one embodiment of the subject application, there is provided a system and method for providing remote service to functionally constrained data processing devices.

Further, in accordance with one embodiment of the subject application, there is provided a system and method for providing services typically unavailable to devices which lack an ability to perform them on their own, such as with cell phones, personal digital assistants, electronic mail devices, and the like.

Still further, in accordance with one embodiment of the subject application, there is provided a remote service system for functionally constrained data processing devices. The system comprises means adapted for data communication with each of a plurality of functionally constrained data processing devices and means adapted for data communication with an associated data repository. The system also comprises means adapted for receiving feature identification data representative of at least one of a plurality of services requested from each of the plurality of data processing devices and a memory adapted for storing instructions corresponding to each of the plurality of available services. The system also comprises testing means adapted for testing received feature identification data for local feature availability and means adapted for processing instructions associated with each received feature identification data so as to complete at least one service therefor. The system further comprises means adapted for accessing the associated data repository in accordance with an output of the testing means and means adapted for communicating result data associated with each requested service to a data processing device associated with request data therefor.

In one embodiment of the subject application, the associated data repository includes the Internet

In another embodiment of the subject application, the available services include obtaining of selected data from the Internet, and wherein the system further comprises means adapted for communicating the selected data as result data.

In a further embodiment of the subject application, the available services include at least one service from the set comprising data storage, data processing, image processing, information retrieval, and document processing.

In yet another embodiment of the subject application, the functionally constrained data processing devices are from the set comprising a cell phone, personal digital assistant device, thin client device, and electronic mail appliance.

In another embodiment of the subject application, the system further comprises means adapted for formatting result data in accordance with a property of a targeted data processing device.

Still further, in accordance with one embodiment of the subject application, there is provided a method for providing remote service to functionally constrained data processing devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a remote service system for functionally constrained data processing devices according to one embodiment of the subject application;

FIG. 2 is a block diagram illustrating a server for use in the remote service system for functionally constrained data processing devices according to one embodiment of the subject application;

FIG. 3 is a flowchart illustrating a remote service method for functionally constrained data processing devices according to one embodiment of the subject application; and

FIG. 4 is a flowchart illustrating a remote service method for functionally constrained data processing devices according to one embodiment of the subject application.

### DETAILED DESCRIPTION OF THE PREFERRED EMBODIMENT

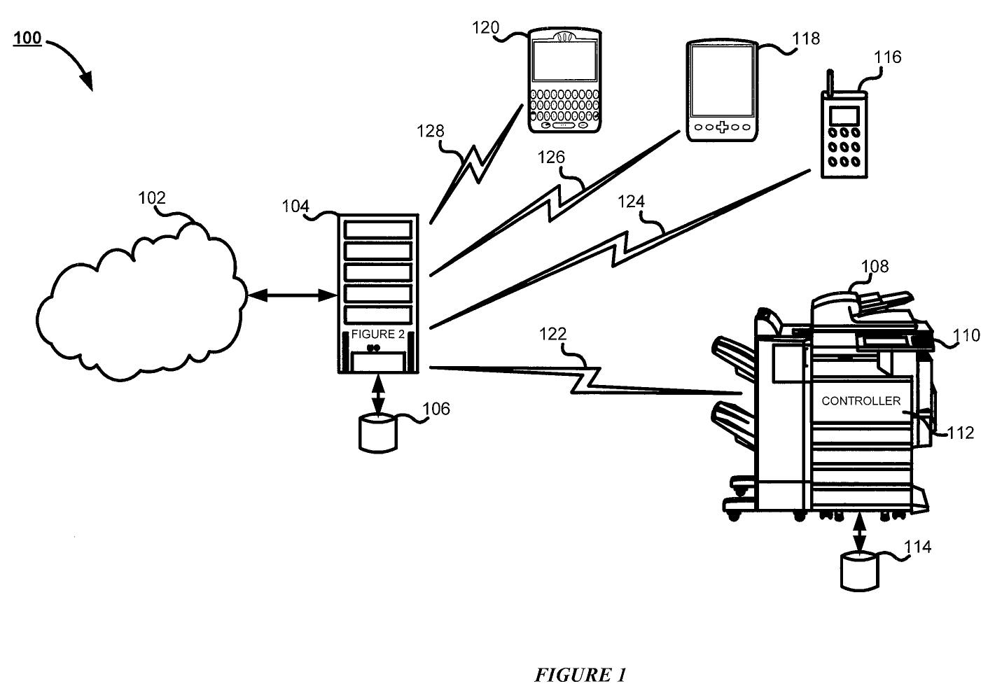

The subject application is directed to a system and method for providing remote service to functionally constrained data processing devices. In particular, the subject application is directed to a system and method for providing services typically unavailable to devices which lack an ability to perform them on their own, such as with as cell phones, personal digital assistances, electronic mail devices, and the like. It will become apparent to those skilled in the art that the system and method described herein are suitably adapted to a plurality of varying electronic fields employing computer networks, including, for example and without limitation, communications, general computing, data processing, document processing, or the like. The preferred embodiment, as depicted in FIG. 1, illustrates a data processing field for example purposes only and is not a limitation of the subject application solely to such a field.

Referring now to FIG. 1, there is shown an overall diagram of a system 100 for providing remote service to functionally constrained data processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

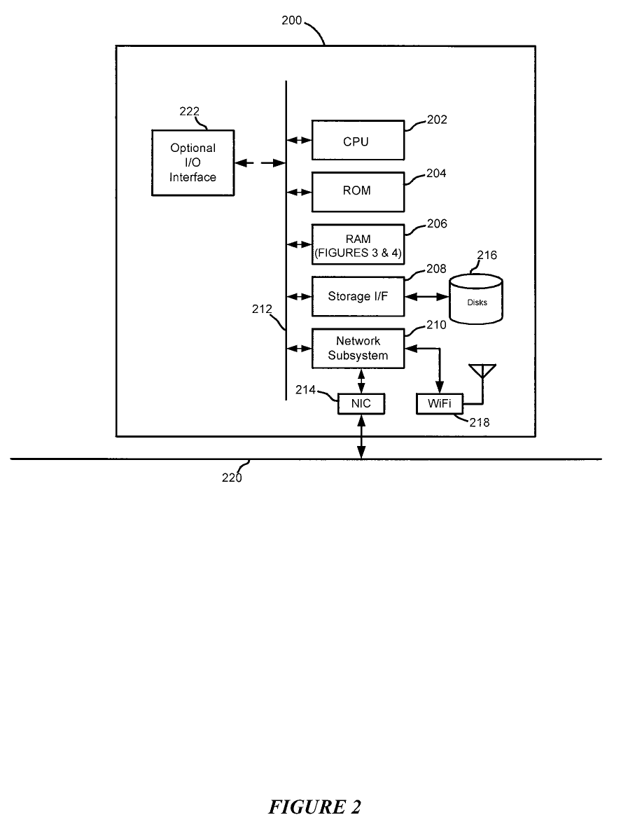

The system 100 also includes a server 104 communicatively coupled to the computer network 102. In accordance with one embodiment of the subject application, the server 104 is representative of any host electronic device capable of providing a plurality of services to one or more personal computing devices. As shown in FIG. 1, the server 104 includes a data storage device 106, suitably adapted for the storage of applications, service information, data processing device information, feature identification information, instruction data corresponding to available services, user account information, and the like. The skilled artisan will appreciated that the data storage device 106 is any mass storage device known in the art including, for example and without limitation, magnetic storage drives, a hard disk drive, optical storage devices, flash memory devices, or any suitable combination thereof. The functioning of the server 104 will better be understood in conjunction with the block diagram illustrated in FIG. 2, explained in greater detail below.

The system 100, shown in FIG. 1, includes a document processing device 108, depicted as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba c-Studio Series Controller. In accordance with one aspect of the subject application, the document processing device 108 is suitably adapted to provide remote document processing services to external or network devices. Preferably, the document processing device 108 includes hardware, software, and any suitable combination thereof, configured to interact with an associated user, a networked device, or the like.

According to one embodiment of the subject application, the document processing device 108 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 108 further includes an associated user interface 110, such as a touch-screen, LCD display, touch-panel, alpha-numeric keypad, or the like, via which an associated user is able to interact directly with the document processing device 108. In accordance with the preferred embodiment of the subject application, the user interface 110 is advantageously used to communicate information to the associated user and receive selections from the associated user. The skilled artisan will appreciate that the user interface 110 comprises various components, suitably adapted to present data to the associated user, as are known in the art. In accordance with one embodiment of the subject application, the user interface 110 comprises a display, suitably adapted to display one or more graphical elements, text data, images, or the like, to an associated user, receive input from the associated user, and communicate the same to a backend component, such as a controller 112, as explained in greater detail below. It will be appreciated by those skilled in the art that the user interface 110 is suitably capable of functioning as a thin client, wherein services are requested via the document processing device 108 and performed by the server 104, as will be set forth in greater detail below.

Preferably, the document processing device 108 is communicatively coupled to the computer network 102 via a suitable communications link 122. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

In accordance with one embodiment of the subject application, the document processing device 108 further incorporates a backend component, designated as the controller 112, suitably adapted to facilitate the operations of the document processing device 108, as will be understood by those skilled in the art. Preferably, the controller 112 is embodied as hardware, software, or any suitable combination thereof, configured to control the operations of the associated document processing device 108, facilitate the display of images via the user interface 106, direct the manipulation of electronic image data, and the like. For purposes of explanation, the controller 112 is used to refer to any myriad of components associated with the document processing device 108, including hardware, software, or combinations thereof, functioning to perform, cause to be performed, control, or otherwise direct the methodologies described hereinafter. It will be understood by those skilled in the art that the methodologies described with respect to the controller 112 are capable of being performed by any general purpose computing system, known in the art, and thus the controller 112 is representative of such a general computing device and is intended as such when used hereinafter. Furthermore, the use of the controller 112 hereinafter is for the example embodiment only, and other embodiments, which will be apparent to one skilled in the art, are capable of employing the system and method for providing remote service to functionally constrained data processing devices of the subject application.

Communicatively coupled to the document processing device 108 is a data storage device 114. In accordance with the preferred embodiment of the subject application, the data storage device 114 is any mass storage device known in the art including, for example and without limitation, magnetic storage drives, a hard disk drive, optical storage devices, flash memory devices, or any suitable combination thereof. In the preferred embodiment, the data storage device 114 is suitably adapted to store a document data, image data, electronic database data, or the like. It will be appreciated by those skilled in the art that while illustrated in FIG. 1 as being a separate component of the system 100, the data storage device 114 is capable of being implemented as internal storage component of the document processing device 108, a component of the controller 112, or the like, such as, for example and without limitation, an internal hard disk drive, or the like.

The system 100 further includes a plurality of functionally constrained data processing devices, illustrated in FIG. 1 as a cellular telephone 116, a personal data assistant 118, and an electronic mail appliance 120. The skilled artisan will appreciate that the devices 116-120 are shown in FIG. 1 for example purposes only, and other types of functionally constrained devices, as are known in the art, are equally capable of implementation in accordance with the subject application. The devices 116-120 are in data communication with the server 104 via a respective number of communications links 124-128. As will be understood by those skilled in the art, the communications links 124-128 are representative of any suitable communications channels known in the art including, for example and without limitation, an intranet, WiMax, 802.11a, 802.11b, 802.11g, 802.11(x), Bluetooth, the public switched telephone network, a proprietary communications network, infrared, optical, or any other suitable wired or wireless data transmission channels known in the art. According to one embodiment of the subject application, the data processing devices 116-120 include limited processing capacity, memory, applications, or the like. In accordance with a further embodiment of the subject application, the data processing devices 116-120 are also capable of requesting one or more services to be performed by the server 104 via the respective communications links 124-128, as explained in greater detail below.

Turning now to FIG. 2, illustrated is a representative architecture of a suitable server 200, shown in FIG. 1 as the server 104, on which operations of the subject system are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the server 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the server 200 to communicate to other devices. The network interface subsystem 210 suitably interfaces with one or more connections with external devices to the server 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the server 200 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 222 as will be appreciated by one of ordinary skill in the art.

In operation, feature identification data representing at least one of a plurality of available services requested from each of a plurality of data processing devices is first received. Instructions corresponding to each of the plurality of available services is then stored. The feature identification data is then tested so as to determine whether the feature is available locally. The instructions associated with each received feature identification data are then processed so as to complete a service corresponding thereto. An associated repository is then accessed when the result of the testing indicates that the feature is not available locally. Thereafter, result data associated with each requested service is then communicated to the data processing device associated with the service request.

In accordance with one example embodiment of the subject application, a server 104 or other suitable device receives data corresponding to services available to a variety of data processing devices, e.g., the document processing device 108, the cellular phone 116, the personal data assistant 118, the electronic mail appliance 120, and the like. The skilled artisan will appreciate that each of the aforementioned data processing devices 108, 116-120, correspond to functionally constrained devices. That is, each of the devices contains limited data processing capabilities. In accordance with one embodiment of the subject application, suitable available services include, for example and without limitation, data retrieval from the Internet, data storage, data processing, image processing, information retrieval, document processing, or the like.

The server 104 then receives instructions corresponding to each available service. The skilled artisan will appreciate that such instructions represent applications to be invoked, data to be generated, operations to be completed to perform a particular service, and the like. The server 104 then stores the received service data and the corresponding instructions in an associated data storage device 106. Preferably, the stored data is thereafter accessible by the server 104 for use in the locating and performance of services requested from the functionally constrained data processing devices 108, 116, 118, and 120.

Upon receipt of a service request from a data processing device 108, 116, 118, 120, or the like, the server 104 or other suitable host device, then determines the feature identification representing the received service request. That is, the server 104 identifies the service needed or requested based upon the feature or features specified in the request received from the data processing device 108, 116, 118, or 120. The received feature identification data is then tested by the server 104 so as to determine whether or not the service specified by the identification data is a locally available service, e.g., one that the server 104 is capable of performing without access to external services, devices, or the like. When the server 104 determines that it is not capable of performing the service locally, or when the requested service is specifically referenced as an external service, e.g., an Internet search, the server 104 accesses the service via the Internet 102. For example, the electronic mail appliance 120 desires to perform a web search using a suitable search engine, e.g., GOOGLE, YAHOO, or the like, the server 104 accesses the appropriate engine via the Internet 102 to retrieve results in accordance with the request from the device 120.

The server 104 then determines, based upon the data processing device 108, 116, 118, or 120, which requested the service, whether the resulting data from the externally performed service must be formatted so as to render the data understandable by the respective device 108, 116, 118, or 120. When the result data is not currently understandable by the device 108, 116, 118, or 120, the server 104 determines, based upon the device, the appropriate format to which the result data is to be converted. The server 104 then converts the data into the format determined to be understandable by the device 108, 116, 118, or 120 associated with the service request. Thereafter, the server 104 communicates the reformatted result data to the requesting device 108, 116, 118, or 120 over the respective communications links 122, 124, 126, or 128.

In the event that the server 104 determines, based upon the feature identification data, that the requested service is locally available, e.g., the server 104 is capable of performing the service without the need to access any external sources, the server 104 retrieves the instructions from the data storage device 106 corresponding to the selected service. Thereafter, the server 104 processes the instructions so as to complete the requested service. The server 104 then determines, based upon the resulting data from the service and the device type, whether the data must first be converted to a format compatible with the requesting device 108, 116, 118, or 120. When formatting is not required, e.g., the device 108, 116, 118, or 120 is capable of understanding the result data without reformatting, the server 104 communicates the data to the requesting device 108, 116, 118, or 120. When formatting is required, the server 104 retrieves the appropriate format type associated with the requesting device 108, 116, 118, or 120 from the data storage device 106 and converts the result data into the specified format. Thereafter, the server 104 communicates the data to the requesting device 108, 116, 118, or 120 via the respective communications links 122, 124, 126, or 128.

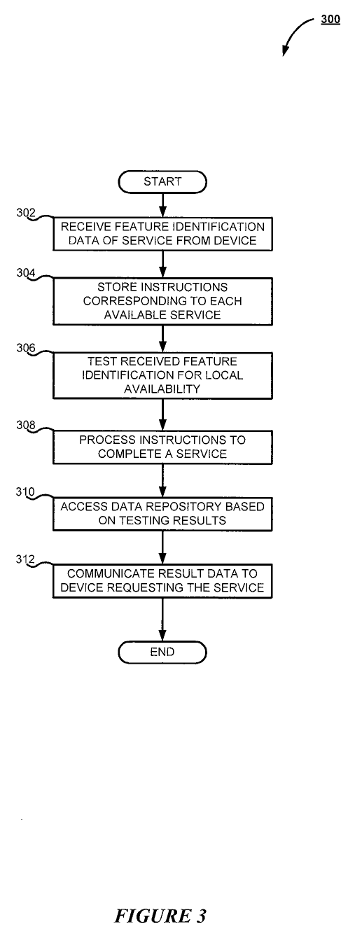

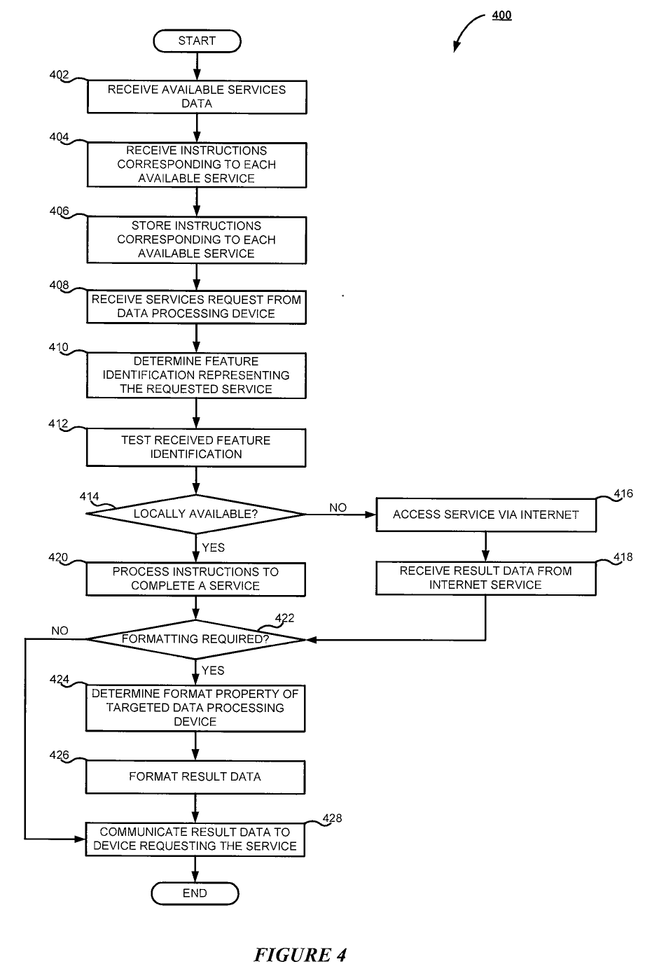

The skilled artisan will appreciate that the subject system 100 and components described above with respect to FIG. 1 and FIG. 2 will be better understood in conjunction with the methodologies described hereinafter with respect to FIG. 3 and FIG. 4. Turning now to FIG. 3, there is shown a flowchart 300 illustrating a method for providing remote service to functionally constrained data processing devices in accordance with one embodiment of the subject application. Beginning at step 302, feature identification data representative of an available service, is received by the server 104 from a data processing device 108, 116, 118, or 120. Next, the server 104, at step 304, stores instructions corresponding to each available service in an associated data storage device 106. In accordance with one embodiment of the subject application, the server 104 is capable of storing, via the data storage device 106, instructions for performing a plurality of local and remote services for a requesting data processing device 108, 116, 118, and 120. The skilled artisan will appreciate that suitable services include, for example and without limitation, Internet data retrieval operations, data storage, data processing, image processing, information retrieval, document processing, and the like. As will be apparent to those skilled in the art, each of the services includes a set of instructions interpretable by the server 104 to perform a related set of functions, thereby performing a requested service, e.g., generating data, storing data, retrieving data, and the like.

The server 104 then tests, at step 306, the feature identification data received from the data processing device 108, 116, 118, or 120, to determine local availability of the service associated with the feature identification data. Stated another way, the server 104 determines, based upon the type of service requested by the device 108, 116, 118, or 120, whether the server 104 is capable of locally performing the service, e.g., the service does not require the server 104 to access the Internet 102 to complete the service. Examples of such services capable of being performed locally include, without limitation, data retrieval from storage 106, image processing, data storage, document processing, and the like. At step 308, the server 104 processes the stored instructions corresponding to the requested service to generate result data. The server 104, at step 310, accesses a data repository, e.g., the Internet 102, when it is determined that the service is not locally available. The skilled artisan will appreciate that step 310 corresponds to the server 104 accessing the Internet, performing or procuring the request service, and thereby generating result data representing the completed operation. Thereafter, at step 312, the server 104 communicates the result data to the requesting device 108, 116, 118, or 120.

Referring now to FIG. 4, there is shown a flowchart 400 illustrating a method for providing remote service to functionally constrained data processing devices in accordance with one embodiment of the subject application. The methodology of FIG. 4 begins at step 402, whereupon data corresponding to available services is received by a server 104. In accordance with one embodiment of the subject application, the service data corresponds to those services that the server 104 is capable of providing, locally or remotely, to a requesting data processing device 108, 116, 118, or 120. At step 404, the server 104, receives instructions corresponding to each available service. The skilled artisan will appreciate that the instructions the server 104 receives correspond to operations the server 104 is required to perform in order to complete the corresponding service. The instructions, and corresponding service data, is then stored, at step 406, in the data storage device 106 associated with the server 104.

At step 408, the server 104 receives a service request from an associated data processing device, e.g., the document processing device 108, the cellular telephone 116, the personal data assistant device 118, the electronic mail appliance 120, or the like. The server 104, at step 410, then determines the feature identification representing the requested service from the service request. In accordance with one embodiment of the subject application, the service request includes feature identification data representative of the desired service. Preferably, the feature identification data is capable of being interpreted by the server 104 so as to facilitate a determination of the specific service being requested. The received feature identification data is then tested by the server 104 at step 412 to determine, at step 414, whether the service is capable of being performed locally, i.e., by the server 104 without accessing the Internet 102. When the server 104 determines, at step 414, that the requested service, as identified by the feature identification data, is not locally available, flow proceeds to step 416, whereupon the server 104 accesses the requested service via the Internet 102. Result data is then received from the Internet service at step 418 and flow progresses to step 422, discussed in greater detail below.

When it is determined by the server 104 at step 414 that the requested service is locally available, flow proceeds to step 420, whereupon the server 104 retrieves the instructions associated with the requested service from the data storage device 106 and processes the instructions to complete the service, thereby generating appropriate result data. A determination is then made at step 422 whether the result data must first be converted to a format understandable by the requesting device 108, 116, 118, or 120. That is, the server 104 compares the received result data format to the formats that are understandable by the requesting device 108, 116, 118, or 120. When the result data is understandable in its current form, flow proceeds to step 428, whereupon the server 104 communicates the result data to the device 108, 116, 118, or 120 that requested the service.

When the server 104 determines at step 422 that the result data must first be converted prior to transmission to the requesting device 108, 116, 118, or 120, flow proceeds to step 424, whereupon the server 104 determines the format properties of the targeted data processing device 108, 116, 118, or 120. The result data is then formatted by the server 104 at step 426. Thereafter, at step 428, the server 104 communicates the formatted result data to the data processing device 108, 116, 118, or 120 associated with the service request.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A remote service system for functionally constrained data processing devices comprising:
means adapted for data communication with each of a plurality of functionally constrained data processing devices;
means adapted for data communication with an associated data repository;
means adapted for receiving feature identification data representative of at least one of a plurality of available services requested from each of the plurality of data processing devices;
a memory adapted for storing instructions corresponding to each of the plurality of available services;
testing means adapted for testing received feature identification data for local feature availability;
means adapted for processing instructions associated with each received feature identification data so as to complete at least one service therefor;
means adapted for accessing the associated data repository in accordance with an output of the testing means; and
means adapted for communicating result data associated with each requested service to a data processing device associated with request data therefor.

2. The remote service system of claim 1 wherein the associated data repository includes the Internet.

3. The remote service system of claim 1 wherein available services include obtaining of selected data from the Internet, and wherein the system further comprises means adapted for communicating the selected data as result data.

4. The remote service system of claim 1 wherein the available services include at least one service from the set comprising data storage, data processing, image processing, information retrieval, and document processing.

5. The remote service system of claim 1 wherein the functionally constrained data processing devices are from the set comprising a cell phone, personal digital assistant device, thin client device, and electronic mail appliance.

6. The remote service system of claim 1 further comprising means adapted for formatting result data in accordance with a property of a targeted data processing device.

7. A remote service method for functionally constrained data processing devices comprising the steps of:
receiving feature identification data representative of at least one of a plurality of available services requested from each of a plurality of data processing devices;
storing instructions corresponding to each of the plurality of available services;
testing received feature identification data for local feature availability;
processing instructions associated with each received feature identification data so as to complete at least one service therefor;
accessing an associated data repository in accordance with an output of the testing step; and
communicating result data associated with each requested service to a data processing device associated with request data therefor.

8. The remote service method of claim 7 wherein the associated data repository includes the Internet.

9. The remote service method of claim 7, further comprising the steps of:
obtaining selected data from the Internet; and
communicating the selected data as result data.

10. The remote service method of claim 7 wherein the available services include at least one service from the set comprising data storage, data processing, image processing, information retrieval, and document processing.

11. The remote service method of claim 7 wherein the functionally constrained data processing devices are from the set comprising a cell phone, personal digital assistant device, thin client device, and electronic mail appliance.

12. The remote service method of claim 7 further comprising the step of formatting result data in accordance with a property of a targeted data processing device.

13. A computer-implemented method for providing remote service to functionally constrained data processing devices comprising the steps of:
receiving feature identification data representative of at least one of a plurality of available services requested from each of a plurality of data processing devices;
storing instructions corresponding to each of the plurality of available services;
testing received feature identification data for local feature availability;
processing instructions associated with each received feature identification data so as to complete at least one service therefor;
accessing an associated data repository in accordance with an output of the testing step; and
communicating result data associated with each requested service to a data processing device associated with request data therefor.

14. The computer-implemented method of claim 13 wherein the associated data repository includes the Internet.

15. The computer-implemented method of claim 13, further comprising the steps of:
obtaining of selected data from the Internet; and
communicating the selected data as result data.

16. The computer-implemented method of claim 13 wherein the available services include at least one service from the set comprising data storage, data processing, image processing, information retrieval, and document processing.

17. The computer-implemented method of claim 13 wherein the functionally constrained data processing devices are from the set comprising a cell phone, personal digital assistant device, thin client device, and electronic mail appliance.

18. The computer-implemented method of claim 13 further comprising the step of formatting result data in accordance with a property of a targeted data processing device.
